(19) United States
(12) Patent Application Publication
(10) Pub. No.: US 2007/0113354 A1
(43) Pub. Date: May 24, 2007

(54) Leather and textile treatment method

(76) Inventor: Donna Joy Guinn, Glenwood, IL (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/653,045

(22) Filed: Jan. 11, 2007

Related U.S. Application Data
(63) Continuation of application No. 10/045,753, filed on Jan. 11, 2002.

(51) Int. Cl. C11D 3/00

(52) U.S. Cl. 8/115.51

(57) ABSTRACT

A method of treating a textile, and particularly a leather surface, includes the steps of applying a pre-cured silicone emulsion to the textile, wiping a surface of the textile to remove any excess pre-cured silicone emulsion, and drying the leather.

### FIELD OF THE INVENTION

The present invention relates generally to the treatment of textiles and, more particularly, to a method of treating leather that uses a pre-cured silicone emulsion to inhibit the penetration of moisture and liquid water into the leather surface. The method is highly effective in producing textile goods that are soft, supple, and waterproof.

### DESCRIPTION OF THE RELATED ART

The use of silicone to treat leather and other textiles is well -known. Typically, a paste or liquid containing an uncured silicone compound is applied to an outer surface of a leather or textile product, and is rubbed into the surface to facilitate the penetration of the silicone compound. The silicone compound may be allowed to cure at an ambient temperature that is about room temperature and, in other cases, the textile product may be subjected to an elevated temperature to cure the silicone compound. In any event, uncured silicone compounds tend to significantly darken the surface of the textile product, particularly where the textile is leather.

In the case application to leather, silicone compounds that are cured at an elevated temperature may cause the surface finish of the leather product to be irreparably damaged as a result of the natural oils in the leather being depleted. While heat-cured silicone compounds generally offer a greater degree of moisture and liquid protection than conventional silicone compounds that are cured at a lower temperature, heat curing is particularly undesirable for many leather products such as garments (e.g., coats, pants, etc.) and accessories (e.g, handbags, wallets, etc.) because loss of the natural oils and damage to the surface finish are especially objectionable to consumers of these types of leather products. Further, the loss of the natural oils during heat curing may severely compromise the useful life of the leather product by making the leather prone to cracking, tearing, fading, etc.

Accordingly, there is a need in the art for a method for treating textiles, and particularly leather, that results in a high degree of protection from moisture and liquid, but does not cause undesirable damage to the surface finish or discoloration. Pre-cured silicone emulsions applied according to the method of this invention avoid these problems, as will be discussed in greater detail below.

### SUMMARY OF THE INVENTION

The methods of this invention address the need in the art for an effective method for treating textiles, particularly leathers (both natural and synthetic), as well as other fabrics where imparting water resistance is important. More specifically, and in accordance with one aspect of the invention, a method of treating a textile to impart water resistance includes the steps of applying a pre-cured silicone emulsion to the textile, wiping the textile to remove any excess pre-cured silicone emulsion, and drying the textile.

The step of drying the textile may further comprise drying the leather surface at a temperature between about 32 degrees Fahrenheit and about 130 degrees Fahrenheit, and the step of applying the pre-cured silicone emulsion to the leather surface may further comprise spraying the pre-cured silicone emulsion on the leather surface. Additionally, the step of wiping the leather surface to remove any excess pre-cured silicone emulsion may further comprise using an absorbent material to wipe the leather surface.

In accordance with another aspect of the invention, a method of treating a leather good includes the steps of applying a pre-cured silicone emulsion to the leather good, and drying the leather good.

The step of drying the leather good may further comprise drying the leather good at a temperature between about 32 degrees Fahrenheit and about 130 degrees Fahrenheit, and the step of applying the pre-cured silicone emulsion to the leather surface may further comprise spraying the pre-cured silicone emulsion on the leather surface. Additionally, the step of wiping the leather surface to remove any excess pre-cured silicone emulsion may further comprise using an absorbent material to wipe the leather surface.

In accordance with yet another aspect of the invention, a method of treating a leather surface includes the steps of spraying a diluted, pre-cured silicone emulsion on the leather surface, wherein the pre-cured silicone emulsion is diluted using from about six parts water to about one part pre-cured silicone emulsion to about 10 parts water to about one part pre-cured silicone emulsion, wiping the leather surface to remove any excess pre-cured silicone emulsion, and drying the leather surface at a temperature between about 32 degrees Fahrenheit and about 130 degrees Fahrenheit.

It will be apparent to those skilled in the art that only the preferred embodiments have been described by way of exemplification, and that there are various modifications that fall within the scope of this invention. These and other aspects of this invention will be discussed in greater detail below.

### DESCRIPTION OF THE PREFERRED EMBODIMENTS

While the present invention will be described primarily with respect to a method for treating leather, it is to be understood that the features thereof will find applicability to other areas, such as the treatment of other textiles, fabrics, synthetic materials, etc., to impart water and moisture resistance, UV protection, and provide improved softness, suppleness, and hand feel. The term “pre-cured silicone emulsion” as used herein is meant to refer to a composition containing a cured, or crosslinked, silicone compound that is emulsified in water or another solvent, and is not meant to be limited to any particular silicone compound.

Presently preferred pre-cured silicone emulsions include, for example. CT 27E or EAF-1500, both of which are commercially available from Kelmar Industries, which is located in Duncan, S. C. However, any emulsion of a cured, crosslinked silicone compound that is capable of imparting water and moisture resistance to natural or synthetic leathers, or other fabrics or textiles, whether natural or synthetic, may be used according to the methods of this invention. The compositions used in the method of this invention should also be capable of protecting the textile to which it is applied, while not causing undesirable surface characteristics, such as darkening.

The method of this invention may optionally include the step of diluting the pre-cured silicone emulsion with a solvent, such as water, prior to its application to the textile surface, where the textile is preferably leather. The solvent may be water, or it may be any other liquid capable of functioning as a solvent for the pre-cured silicone emulsion, including alcohols. Although tap water may be used to dilute the precured silicone emulsion prior to application, any other type of water such as distilled water, de-ionized water, etc., may be used without significantly affecting the results achieved. According to a presently preferred aspect of the invention, the pre-cured silicone emulsion is diluted using a ratio of about seven parts water to about one part pre-cured silicone emulsion. However, other suitable dilution ratios may be used without departing from the scope and the spirit of the invention. For example, a dilution ratio of about six parts solvent to about one part pre-cured silicone emulsion or a dilution ratio of about ten parts solvent to about one part pre-cured silicone emulsion may be used to suit a particular application. Generally speaking, the type of textile, the finish of the textile surface, the degree of moisture and liquid protection desired, and various other factors known to those skilled in the art will determine the optimal dilation ratio.

The diluted pre-cured silicone emulsion may then be poured into a spray bottle having an atomizing spray head or, alternatively, the emulsion may be dispensed into a pressurized aerosol container or the like. In any case, the diluted emulsion is preferably, but not necessarily, put into a dispensing or application device that produces a fine mist of diluted silicone emulsion. It is also envisioned that the pre-cured silicone emulsion may be applied without dilution by wiping it onto the surface of the textile being treated.

The diluted silicone emulsion may be applied as a fine mist to a surface of the textile being treated, or the undiluted emulsion may be applied directly to the surface of the textile by rubbing, brushing, or other appropriate means. Importantly, because the emulsion contains pre-cured silicone, the ambient temperature during application of the diluted silicone emulsion should range between about 32 degrees Fahrenheit and about 130 degrees Fahrenheit, or more preferably between about 34 degrees Fahrenheit and about 110 degrees Fahrenheit, and the emulsion is most preferably applied at about room temperature (approximately 72 degrees Fahrenheit). In other words, because the silicone is pre-cured, high temperatures are unnecessary, as no heat curing is needed. It is advantageous to maintain the temperature during application of the pre-cured silicone emulsion below about 130 degrees Fahrenheit, particularly where the textile being treated is a leather, because this prevents the natural oils present in the leather from being depleted, thereby preserving the finish, texture, feel, suppleness, and durability characteristics of the leather.

After applying the pre-cured silicone emulsion to the textile surface, the emulsion may be allowed to remain undisturbed on the textile surface for a length of time, such as, for example, about thirty seconds. However, any other suitable length of time may be used instead, or the emulsion may be wiped off of the surface immediately after application. The textile surface may, if desired, be wiped using an absorbent material to remove any excess pre-cured silicone emulsion. Alternatively, the excess emulsion may be worked into the textile surface using bare hands or suitable tools. Once any excess emulsion has been removed or worked into the surface of the textile being treated, the textile is allowed to dry. The drying time may vary depending on the type of textile being treated, the temperature during drying, the dilution ratio used, the amount of emulsion applied, etc. The pre-cured silicone impregnates the pores of the textile surface to inhibit liquid and moisture from penetrating the textile. Because the silicone is pre-cured and is transparent, application of the emulsion to the textile surface does not perceptibly discolor or darken the textile, and this is particularly beneficial when the textile being treated is a leather.

The method of treating a textile by applying a pre-cured silicone emulsion may be repeated multiple times without causing a buildup on the textile surface, which can be a problem when using conventional textile treatments that comprises uncured silicone. Still further, because the pre-cured silicone emulsion impregnates the pores of the textile being treated, it may remain intact and effective for many months, and may be particularly useful in helping to prevent problems frequently encountered with leathers such as dry rot, cracking, etc., while at the same time enabling the leather good or surface to repel or prevent moisture and/or liquid from penetrating the leather surface.

Thus, what has been described is a method for treating textiles, and particularly leather, to impart moisture and liquid resistance, UV resistance, and improved hand feel, suppleness, and other physical characteristics, without causing discoloration or build-up on the textile. While the present invention has been described with respect to what are presently considered to be the preferred embodiments, it is to be understood that the invention is not limited to the disclosed embodiments. To the contrary, the invention is intended to cover various modifications and equivalent arrangements included within the spirit and scope of the appended claims. Therefore, the scope of the following claims is to be accorded the broadest interpretation so as to encompass all such modifications and equivalents.

What is claimed is:

1. A method of treating a textile to impart water resistance, comprising the steps of:
applying a pre-cured silicone emulsion to the textile;
wiping the textile to remove any excess pre-cured silicone emulsion; and
drying the textile.

2. The method of claim 1, wherein the temperature at which the pre-cured silicon emulsion is applied and the temperature at which the textile is dried is between about 32 degrees Fahrenheit and about 130 degrees Fahrenheit.

3. The method of claim 1, wherein the pre-cured silicone emulsion is applied by spraying the pre-cured silicone emulsion on the textile.

4. The method of claim 1, wherein the step of wiping the textile to remove any excess pre-cured silicone emulsion is carried out using an absorbent material.

5. The method of claim 1, wherein the pre-cured silicon emulsion is diluted prior to its application to the textile.

6. The method of claim 5, wherein the pre-cured silicon emulsion is diluted using about seven parts water to about one part pre-cured silicone emulsion.

7. A method of treating a leather good, comprising the steps of:
applying a pre-cured silicone emulsion to the leather good; and
drying the leather good.

8. The method of claim 7, wherein the temperature at which the pre-cured silicon emulsion is applied and the temperature at which the leather good is dried is between about 32 degrees Fahrenheit and about 130 degrees Fahrenheit.

9. The method of claim 7, wherein the step of applying the pre-cured silicone emulsion to the leather good comprises spraying the pre-cured silicone emulsion on the leather good.

10. The method of claim 7, further comprising the step of wiping a surface of the leather good to remove any excess pre-cured silicone emulsion.

11. The method of claim 7, wherein the pre-cured silicon emulsion is diluted prior to its application to the leather good.

12. The method of claim 11, wherein the pre-cured silicon emulsion is diluted using about seven parts water to about one part pre-cured silicone emulsion.

13. A method of treating a leather surface, comprising the steps of:
spraying a diluted, pre-cured silicone emulsion on the leather surface, wherein the pre-cured silicone emulsion is diluted using from about six parts water to about one part pre-cured silicone emulsion to about 10 parts water to about one part pre-cured silicone emulsion;
wiping the leather surface to remove any excess pre-cured silicone emulsion; and
drying the leather surface at a temperature between about 32 degrees Fahrenheit and about 130 degrees Fahrenheit.
